(19) United States
(12) Patent Application Publication
(10) Pub. No.: US 2015/0341097 A1
(43) Pub. Date: Nov. 26, 2015

(54) CSI Feedback with Elevation Beamforming

(71) Applicants: Weidong YANG, Hoffman Estates, IL (US); Eugene VISOTSKY, Buffalo Grove, IL (US); Frederick VOOK, Schaumburg, IL (US); Timothy THOMAS, Palatine, IL (US); Bishwarup MONDAL, Beavercreek, OH (US)

(72) Inventors: Weidong YANG, Hoffman Estates, IL (US); Eugene VISOTSKY, Buffalo Grove, IL (US); Frederick VOOK, Schaumburg, IL (US); Timothy THOMAS, Palatine, IL (US); Bishwarup MONDAL, Beavercreek, OH (US)

(21) Appl. No.: 14/436,671

(22) PCT Filed: Oct. 19, 2012
(86) PCT No.: PCT/US2012/061082

§ 371 Date: Apr. 17, 2015

(51) Int. Cl. H04B 7/06; H04B 7/10; H04L 1/00

(52) U.S. Cl. CPC H04B 7/0617; H04L 1/0023; H04B 7/063; H04B 7/0632; H04B 7/0639; H04B 7/10; H04L 1/0003; H04L 1/0009

(57) ABSTRACT

The specification and drawings present a new method, apparatus and software related product for using elevation beamforming with standardized CSI feedback for evolving deployment scenarios (e.g., in LTE and LTE-A wireless systems). According to an embodiment of the invention, a network element such as eNB may send to a UE reference signals (e.g., CSI-RS) on a plurality of resources or PRBs (e.g., frequency subbands), each resource can be transmitted with one of a plurality of downtilt angles/values. In response, the network element may receive from the UE a feedback report including selected by the UE one or more of the plurality of resources/frequency subbands and related information on PMI/CQI/RI for each selected resource/frequency subband. Then, based on the feedback report, the network element can determine/identify at least one preferred downtilt angle to use for future transmissions to the UE.

### TECHNICAL FIELD

The exemplary and non-limiting embodiments of this invention relate generally to wireless communications and more specifically to using elevation beamforming with standardized CSI feedback for evolving deployment scenarios (e.g., in LTE and LTE-A wireless systems).

### BACKGROUND ART

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section.

The following abbreviations that may be found in the specification and/or the drawing figures are defined as follows:
3GPP third generation partnership project
3D three-dimensional
BP bandwidth part
CQI channel quality indicator
CSI channel state information
CSI-RS channel state information reference signal
DL downlink
EPDCCH enhanced physical downlink control channel
EPDSCH enhanced physical downlink shared channel
E-UTRA evolved universal terrestrial radio access
eNB evolved node B/base station in an E-UTRAN system
ET expected throughput
E-UTRAN Evolved UTRAN (LTE)
HARQ hybrid automatic repeat request
IMR interference measurement resource
LDPC low-density parity check
LTE long term evolution
LTE-A long term evolution advanced
MCS modulation and coding scheme
PRB physical resource block
PDCCH physical downlink control channel
PDSCH physical downlink shared channel
PMI precoding matrix index
RAN radio access network
RI rank indication
SNR signal-to-noise ratio
SINR signal to interference plus noise ratio
UE user equipment
UL uplink
UTRAN universal terrestrial radio access network

CSI feedback has always been a central theme in broadband wireless communications. There are always trade-offs between CSI feedback accuracy and overhead, which can be expressed as uplink resources needed to transmit a large amount of information for the accurate CSI feedback, downlink resources required to enable accurate CSI feedback, and/or the power consumption/computational complexity at the UE for frequency CSI feedback calculations.

### SUMMARY

According to a first aspect of the invention, a method comprising: generating and sending by a network element to a user equipment, reference signals on a plurality of resources, each resource is sent with one of a plurality of downtilt angles; receiving by the network element from the user equipment a feedback report comprising information on selected one or more of the plurality of resources; and determining by the network element at least one preferred downtilt angle for the user equipment based on the information comprised in the feedback report.

According to a second aspect of the invention, an apparatus comprising: a processing system comprising at least one processor and a memory storing a set of computer instructions, in which the processing system is arranged to cause the apparatus to: generating and sending to a user equipment, reference signals on a plurality of resources, each resource is sent with one of a plurality of downtilt angles; receiving from the user equipment a feedback report comprising information on selected one or more of the plurality of resources; and determining at least one preferred downtilt angle for the user equipment based on the information comprised in the feedback report.

According to a third aspect of the invention, a computer program product comprising a computer readable medium bearing computer program code embodied herein for use with a computer, the computer program code comprising: code for generating and sending to a user equipment, reference signals on a plurality of resources, each resource is sent with one of a plurality of downtilt angles; code for receiving from the user equipment a feedback report comprising information on selected one or more of the plurality of resources; and code for determining at least one preferred downtilt angle for the user equipment based on the information comprised in the feedback report.

### BRIEF DESCRIPTION OF THE DRAWINGS

For a better understanding of the nature and objects of embodiments of the invention, reference is made to the following detailed description taken in conjunction with the following drawings, in which:

FIG. 1 shows a typical implementation of an antenna array that has been configured for exploiting the vertical dimension with elevation beamforming.

FIGS. 2a-2b are diagrams demonstrating a principle for using elevation beamforming with standardized CSI feedback, according to an embodiment of the invention;

FIG. 3 is a diagram of an antenna array with 8 antennas, arranged in 4 columns and 2 rows, which can be used for implementing embodiments of the invention;

FIG. 4 is a diagram demonstrating how elevation beamforming can be used in a network to enhance cell edge coverage and cell throughput, according to an exemplary embodiment of the invention;

FIG. 5 is a flow chart demonstrating exemplary embodiments of the invention; and

FIG. 6 is a block diagram of exemplary wireless devices for practicing exemplary embodiments of the invention.

### DETAILED DESCRIPTION

The CSI feedback as understood in the context of LTE usually includes three parts: RI (rank indication), PMI (precoding matrix index), and CQI (channel quality indicator). In some cases a set of subbands selected by a UE may be included within a CSI feedback.

Elevation beamforming typically involves many physical antennas transmitting to a UE where the physical antennas may be arranged vertically in addition to antennas arranged in azimuth. To support elevation beamforming following the design principle of the conventional CSI feedback schemes requires either substantial overhead or requires standard support (change of LTE specifications). The CSI feedback process in general as used in LTE/LTE-A systems can be summarized as follows.

To allow a UE to feedback the desired precoder, a network access node can transmit training signals s from each of its M_{T} transmit antennas which can be either CRS or CSI-RS, and a receiver model for CSI on a single subcarrier (frequency bin or subband) at a single time can be given by

r=Hs+n (1)

where r is a M_{R}×1 received signal (M_{R} is the number of receive antennas), s is a training signal (e.g. CSI-RS signals), H is a M_{R}×M_{T} channel response of the wireless channel, and n is a noise vector.

From Equation 1, the UE can obtain a channel estimate Ĥ of H from channel estimation performed with the known s, which can be either CRS or CSI-RS. The channel estimation is typically performed for each PRB pair (a PRB pair may be defined as a two-dimensional group of resources, 12 subcarriers by 14 OFDM symbols in time) or subband. The UE also needs to estimate a noise variance σ² from the CRS or an interference measurement resource (IMR) which is introduced in LTE 3GPP Release 11. Then the UE can try each codeword (or precoder) in the codebook to calculate an expected throughput from the receiver model below as follows:

r=ĤWⱼx+ñ (2),

where Wⱼ is a M_{T}×r codeword in the codebook with r being a rank of the transmission (where the rank means the number of spatial streams), x is a r×1 transmitted symbol vector, and ñ is a vector noise with a noise variance σ². From this model, a Table 1 below (shown for 4 subbands) can be built as follows:

TABLE 1
Expected throughput (ET) from the receiver model for different codewords.

| | rank 1 | rank 1 | rank 1 | rank 1 | rank 2 | rank 2 |
|---|---|---|---|---|---|---|
| | Trying Codewords | | | | | |
| | W₁ | W₂ | W₃ | W₄ | W₅ | W₆ |
| Subband 1 | ET (1, 1) | ET(1, 2) | ET(1, 3) | ET(1, 4) | ET(1, 5) | ET(1, 6) |
| Subband 2 | ET (2, 1) | ET(2, 2) | ET(2, 3) | ET(2, 4) | ET(2, 5) | ET(2, 6) |
| Subband 3 | ET (3, 1) | ET(3, 2) | ET(3, 3) | ET(3, 4) | ET(3, 5) | ET(3, 6) |
| Subband 4 | ET (4, 1) | ET(4, 2) | ET(4, 3) | ET(4, 4) | ET(4, 5) | ET(4, 6) |

The network can restrict the codebook actually used by the UE by RRC signaling meaning that some codebook entries will not be used by the UE for the CSI reporting. If that is the case, then some columns in the Table 1 corresponding to the restricted codewords may be crossed out. It is possible then to identify an optimal precoder, i.e., the precoder providing the highest expected throughput can be identified for each subband, and the best subband(s) (i.e., the subbands with the high/highest information rates) can be also identified. It should be noted that there may be some restrictions so that the UE can be required to feed back a single PMI or multiple PMIs in the feedback, and further the UE may be required to feedback a single CQI or multiple CQIs in the feedback. The actual feedback schemes in the LTE system can be quite complicated. Nevertheless, the procedure for the CSI feedback is defined herein at a conceptual level.

Elevation beamforming (3D beamforming) has been identified as a useful technique to enhance cell edge and cell throughput (e.g., see “System Level Analysis of Vertical Sectorization for 3GPP LTE”, Yilmaz et.al., Nokia Siemens Networks & Helsinki University, ISWCS 2009). A product structure for the 3D beamforming weight vector has also been identified as a useful tool to simplify the hardware implementation of 3D beamforming and signal processing. As elevation beamforming can provide substantial benefits in terms of sector throughput and cell edge throughput, then it is desirable to support elevation beamforming in an elegant way and make it available to as many UEs as possible, including release 10 UEs.

In 3GPP LTE Release 8 (referred to as “release 8” in the following), support for up to 4 transmit antenna ports was included in the specification. In 3GPP LTE Release 10 (referred to as “release 10” in the following), support for up to 8 transmit antenna ports was included in the specification. The change was accompanied by introducing a new codebook for 8 transmit antennas, and CSI-RS configurations for the desired signal and muting pattern to mitigate the interference to other cells. If elevation beamforming is supported in future releases of LTE (e.g., 3GPP Release 12) by following the same design principles used in developing the changes from release 8 to release 10, then a new codebook and potentially new CSI-RS configurations would need to be introduced. The necessary standardization work could be substantial, and it is clear with this approach that release 10 UEs would not be able to benefit from the use of elevation beamforming.

A new method, apparatus, and software related product (e.g., a computer readable memory) are presented for using elevation beamforming with standardized CSI feedback for evolving deployment scenarios (e.g., in LTE and LTE-A wireless systems). According to an embodiment of the invention, a network element (e.g., eNB) may send to a UE-reference signals (channel state information reference signals, CSI-RS) on a plurality of resources or PRBs (e.g., frequency subbands), where each resource (frequency subband) can be transmitted with one of a plurality of downtilt angles/values. In response, the network element (eNB) may receive from the UE a report (i.e., a feedback report) comprising a preferred selection by the UE of one or more of the plurality of resources/frequency subbands and related information on precoding matrix index(PMI)/channel quality indicator(CQI)/rank indicator(RI) for each selected resource/frequency subband. It is noted that the UE typically does not know the downtilt angles/values used by the network element on each of the different resource/frequency subbands, so the UE makes its preferred selection of the one or more of the plurality of resources/frequency subbands only based on time-frequency information typically determined while receiving the reference signals from the network element (e.g., a calculated overall channel quality or expected channel throughput). Then, based on the feedback report, the network element can identify/determine at least one (or one or more in general) preferred downtilt angle to use for future transmissions to the UE. The at least one preferred downtilt angle for the UE can be determined to be the downtilt that was used to transmit the reference signals in the PRBs that correspond to the preferred sub-bands indicated in the feedback report from the UE. Note that in conjunction with a downtilt angle in elevation, a precoder may be used for transmission to the UE.

The feedback report may be sent by the UE to the network element in one or multiple messages using a frequency selective CSI feedback scheme in general, e.g., in particular using best-M or BP-Best feedback scheme for selected subbands.

Moreover, the feedback message from the UE can indicate the resource/frequency subband that are selected/determined by the UE to be the best for the UE, where the UE can use any number of quantitative measures to determine which resource/frequency subband is best (e.g., for each resource/frequency subband, the UE can compute the data rate supported by each sub-band or the SNR or SINR experienced by the subband). Since the subbands are transmitted with different downtilts, it is reasonable to expect that the subbands that the UE determines to be the best subbands are the subbands that are transmitted with the downtilt value that is best for the UE. A subband that is transmitted with a downtilt value that is pointed away from a UE is expected to be inferior to a subband that is transmitted with a downtilt value pointed right at the UE. The UE's feedback report that indicates which subband(s) are the best can therefore be used by the eNB to determine which downtilt value is best for that UE. The eNB can simply determine that the best downtilt value for the UE is the downtilt value used to transmit the subbands that the UE had determined were the best subband(s). Note that the UE can simply select feed back to the eNB the best subband(s) and that the UE does no other steps that directly support the downtilt selection process. The process described here is one where the UE's best band selection process is transparently (to the UE) transformed into a downtilt selection process, so that transmitting each subband on one of a set of possible downtilt values may result in the best band selection process being equivalent to a best beam selection process.

According to a further embodiment, the network element such as eNB may send data or control information in the downlink, e.g., on an PDSCH or EPDCCH to the UE using the selected one or more resources/frequency subbands using the corresponding mapped downtilt angles where a modulation and coding scheme (MCS) for the sent data may be determined by the network element using the CQI provided by the UE for the selected resource/frequency subband.

It is noted that in embodiments described herein, CSI feedback capabilities as enabled in 3GGP Releases 10 and 11 can be used in different multiple advantageous ways so the elevation beamforming may be enabled with existing LTE-advanced features. The embodiments may include (but are not limited to) the following benefits over conventional CSI feedback techniques to support more transmit antennas:
1. Low overhead;
2. Low specification/standard impact;
3. Elevation beamforming becomes more practical.; and
4. The “best PRB/subband selection” can be transparently transformed into a “best beam selection” process.

It should be noted that in general any frequency selective CSI feedback scheme that involves a method of the UE directly informing the eNB of the relative quality of the different PRBs/subbands can be used with the methodology described herein. Any frequency selective CSI feedback scheme that provides enough information to enable the eNB to indirectly determine the quality of the different PRBs/subbands can also be used with the methodology described herein. As long as the frequency selective CSI feedback scheme enables the eNB to determine the quality of the different PRBs/subbands directly or indirectly (e.g., through additional calculations based on the information provided by the UE), the CSI feedback scheme can be used with the methodology described herein.

One example of a frequency-selective CSI feedback scheme is where the UE may be configured to provide CSI feedback in-subbands determined by the network or may be configured to provide the CSI feedback for all subbands. The UE may report the CSI information for all the configured sub-bands in multiple CSI reports. In this case, the network, upon reception of one or more feedback reports from the UE can determine the best downtilt (elevation beam) suitable for a PDSCH transmission to the UE. For the purpose of this invention multiple feedback reports can be considered to be one report sent by the UE to the network element (eNB) in multiple messages.

Another example of frequency-selective CSI feedback is frequency selective rank indicator in conjunction with the PMI and CQI. The eNB may also indicate to the UE certain restrictions on the selection of the PMI using a codebook subset restriction. This restriction may be indicated in a frequency-selective manner for example, different codebook subset restrictions corresponding to different downtilts may be applied to different frequency bands. Similarly different interference measurement resources may also be applied to different frequency bands. This would then imply a different interference hypothesis for different frequency bands.

Another example embodiment of the invention is where multiple CSI-RS resources are configured for the UE, each resource with a different downtilt. The UE may be configured to provide the CSI feedback corresponding to each of the configured CSI-RS resources using one or more CSI reports. The network, upon reception of these CSI reports may determine the best downtilt (elevation beam) suitable for the PDSCH transmission to the UE. It may also be possible for the UE to determine the best CSI-RS resource among the configured CSI-RS resources and to feedback the selection of the best CSI-RS resource to the eNB. The criteria for determining the best CSI-RS resource at the UE may include spectral efficiency, SINR, etc.

Another exemplary embodiment of the invention is where different downtilts (elevation beams) are applied to different frequency bands for a CSI-RS resource configured for a UE. The UE may either provide a selection of the best subbands or report the CSI feedback for all configured subbands. The eNB could simply allocate PDSCH on the best subbands corresponding to the UE. In this case the eNB does not need to explicitly determine the best downtilt for the UE.

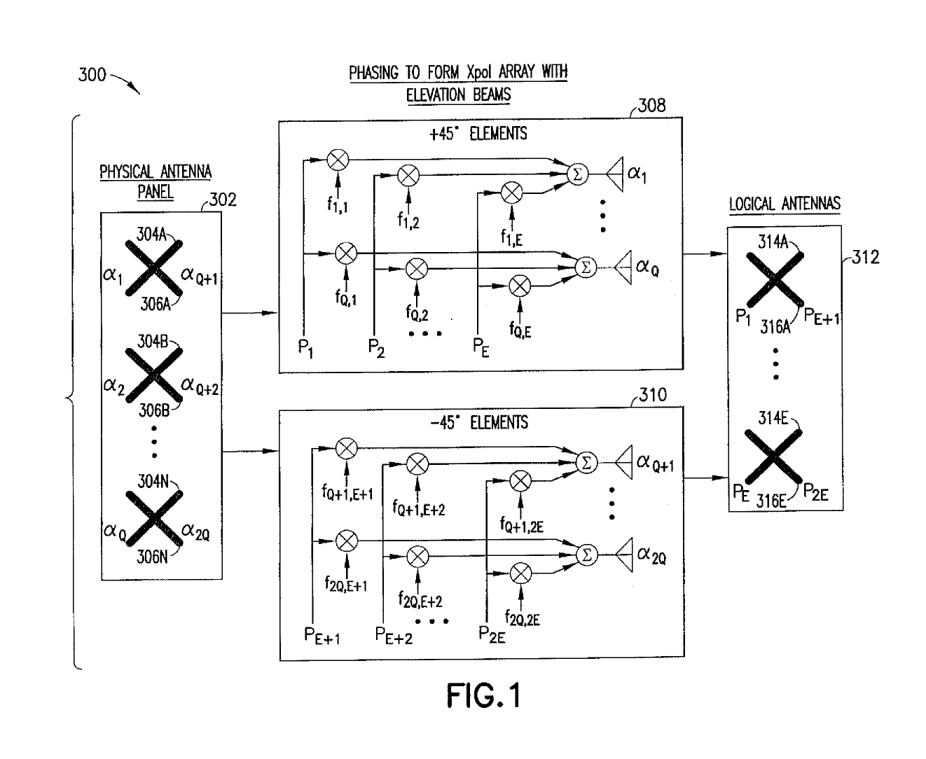

FIG. 1 shows a typical implementation of an antenna array that has been configured for exploiting the vertical dimension with elevation beamforming. FIG. 1 shows the array 300 according to an embodiment of the present invention, comprising a physical antenna panel 302. The physical antenna panel 302 comprises pairs of elements 304A and 306A, 304B and 306B, on through 304N and 306N. The elements 304A, 304B , . . . , 304N may be designated as α₁, α₂, . . . , α_{Q}, respectively, and the elements 306A, 306B , . . . , 306N may be designated as α_{Q+1}, α_{Q+2}, . . . , a_{2Q}, respectively. The elements are subjected to phasing operations 308 and 310, designed to phase all antennas of the corresponding polarization. The signals P₁, P₂, . . . , P_{E}, supplied to the +45-degree elements, are phased by the values f_{1, 1} and f_{Q,1}, f_{1,2} and f_{Q2}, . . . , f_{1,E} and f_{Q,E}. The signals P_{E+1}, P_{E+2}, . . . , P _{2E}, supplied to the −45-degree elements, are phased by the values f_{Q+1,E+1} and f_{2Q,E+1}, f_{Q+1,E+2} and f_{2Q,E+2}, . . . , f_{Q+1,2E} and _{f2Q,2E}. The outputs of the phasing operations are summed to create logical antenna ports 312, comprising logical pairs of elements 314A and 316A through 314E and 316E. Phasing between all antennas allows accurate control over the effective elevation and downtilt. With a proper choice of the phasing factors f_{1,1} . . . f_{Q,1}, f_{1,2} . . . f_{Q2}, f_{1,E} . . . f_{Q,E}, f_{Q+1,E+1} . . . f_{2Q,E+1}, f_{Q-1,E+2} . . . f_{2Q,E+2}, . . . , f_{Q+1,2E} . . . f_{2Q,2E}, the logical antenna ports 314A through 316E can be configured such that each row of the logical array 312 corresponds to a different downtilt value. In other words, ports P₁ and P_{E+1} are both fed to a beamforming/phasing vector that forms a first downtilt value (i.e., the vector [f_{1,1} . . . f_{Q,1}] is identical to the vector [f_{Q+1,E+1} . . . f_{2Q,E+1}] and is chosen to create the vertical pattern corresponding to the first downtilt). Similarly ports P₂ and P_{E+2} are both fed to a beamforming/phasing vector to form a second downtilt value (i.e., the vector [f_{1,2} . . . f_{Q,2}] is identical to the vector [f_{Q+1,E+2} . . . f_{2Q,E-2}] and is chosen to create the vertical pattern corresponding to the second downtilt). Similarly, ports P_{E} and P_{2E} are both fed to a beamforming/phasing vector to form an E^{th} downtilt value (i.e., the vector _{[f}_{1,E} . . . f_{Q,E}] is identical to the vector [f_{Q+1,2E} . . . f_{2Q,2E}] and is chosen to create the vertical pattern corresponding to the E^{th} downtilt).

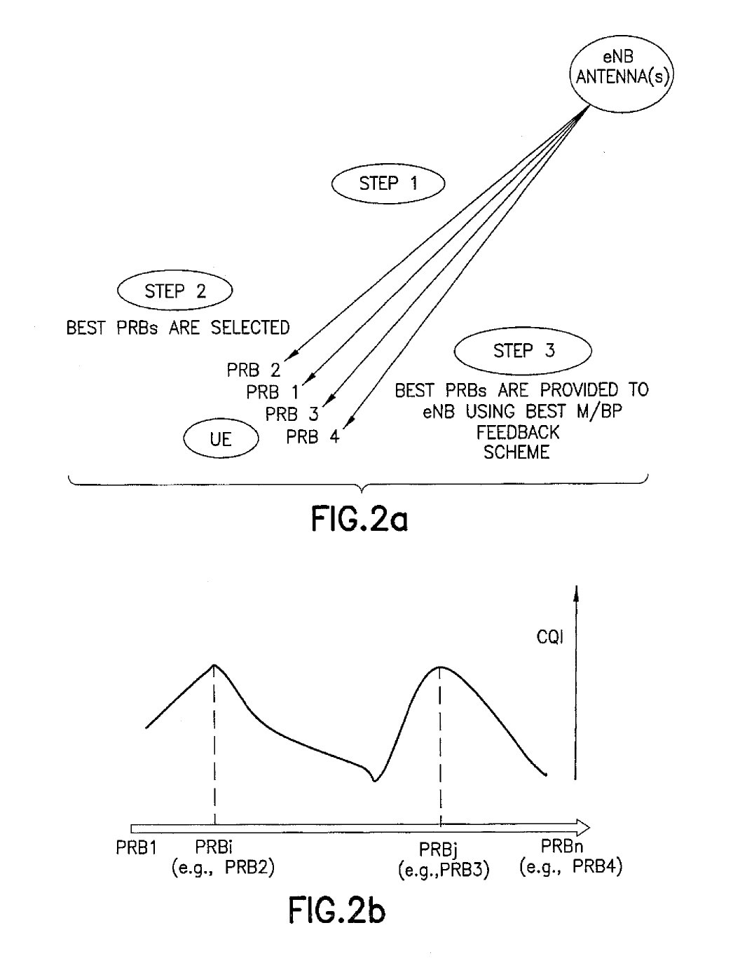

FIGS. 2a-2b demonstrates an exemplary principle for using elevation beamforming with standardized CSI feedback, according to an embodiment of the invention. Step 1 in FIG. 2a corresponds to synthesizing and transmitting by the eNB antenna(s) four different frequency domain resources PRB 1, PRB2, PRB3 and PRB 4 on four elevation beams (in general n PRBs can be used, n being a finite integer of two or more) having different downtilt angles. The eNB will transmit the same downtilt on all of its Mₐ azimuth antennas where azimuth means polarization as well as antennas in the horizontal direction. The UE will then measure the CSI-RS for all of the Mₐ azimuth antennas to determine the feedback as described next.

For example, each LTE frequency subband may use one of several possible downtilt angles/values, and the eNB may establish a set of elevation beams each having different downtilt values. In other words, the eNB can perform an identical phase sweep in the frequency domain across all Mₐ azimuth antennas from, e.g., two sets of elevation antenna ports, where each phase is corresponding to a fixed downtilt angle or a beamspace basis vector, with the same baseband signal at matching antenna ports from each set. (For example, see FIG. 1, where the act of sweeping the phase is where the network element changes the phasing values f_{i,j} in the FIG. 1 to create the vertical pattern that has the desired downtilt value.) The phase sweeping that varies the downtilt angle can be performed in a discrete fashion across the sub-bands in the frequency domain, so that: a) each band/subband is transmitted with a certain elevation downtilt beam, and b) the eNB knows the mapping from a corresponding resource/subband to a corresponding beam, but the UE need not know the mapping. If desired the phase sweeping may be done relatively slowly across frequency so that channel estimation at the UE which assumes some correlation between the CSI-RS on the different PRBs is unaffected.

Thus the eNB can transmit CSI-RS where each frequency subband of the CSI-RS is transmitted with one of the elevation beams in the set, i.e., the beams across the subbands are cycled in frequency in the CSI-RS. In addition, the mapping from elevation beams to subbands can change with time, e.g. different scanning steps can be used, or different segments of phase sweep can be conducted.

In step 2 shown in FIG. 2a, the UE may receive CSI-RS signals from the PRBs where the CSI-RS signals are transmitted with varying downtilt angles, and the selection of PRBs/subbands by a UE using a conventional sub-band selection approach is ultimately used by the eNB as an implicit selection of the preferred downtilt angle(s).

Thus the UE can determine/measure strong signals out of the PRBs that are transmitted with the elevation downtilt(s) that is best for that UE (e.g., using SNR or SINR). As noted herein, the UE does not have and does not need to know any information about downtilt angles of the elevation beams shown in FIG. 2a.

The selection of the best signal(s) (PRB(s)/subband(s)) may be performed by comparison of CQIs (by measuring the channel response) using, for example, 3GPP Release 10 codeword (i.e., Wⱼ which is an Mₐ×r matrix) selected by the UE from the codewords W₁, W₂, . . . , W₆ (having for example ranks (r) 1 and 2, or higher ranks) as shown in Table 1 above for 4 PRB/subbands. It is possible then to identify an optimal precoder, i.e., the precoder providing the highest expected throughput can be identified for each PRB/subband, and the best PRB(s)/subband(s) (i.e., the subbands with the high/highest information rates) can be also identified. For example, as shown in FIG. 2b the chosen PRB/subbands are PRB2 and PRB3, or in general PRBi and PRBj out of total of n PRBs.

Then in step 3 in FIG. 2a, the UE reports the selected (preferred) best PRB(s)/subband(s) along with corresponding PMI/CQI/RI to the eNB using, for example, best M or BP feedback scheme as further described herein. Also if the one or more of the plurality of the preferred resources are frequency subbands, the UE can convey to the network element which resources are preferred via a frequency selective channel state information feedback message that is transmitted by the UE.

The downtilt selection is implicitly built in the CSI feedback report since the sub-bands perceived to be the best by the UE are likely to be the ones that are transmitted with the downtilt angle that is the best for that UE. As a result, the eNB can determine the best downtilt angle(s)/value(s) for the UE from the best PRB(s)/subband(s) that were reported by the UE in the CSI feedback report. Subsequently, the identified downtilt angles(s) for the UE may be applied by the eNB to the transmission on the selected PRBs, and the feedback CQI may be used by the eNB to determine the appropriate MCS level(s).

Furthermore, in elevation beamforming, at each physical elevation antenna, the weighted sum of typically Mₑ=2 beamspace basis vectors can be used to scan a relatively small elevation angle. This means that only Mₑ=2 effective (or virtual) elevation ports are needed to create all of the desired downtilts instead of needing the number of elevation ports equal to the number of physical elevation antennas. A product structure may be enforced for the overall beamforming weight (across azimuth and elevation dimensions) as follows. Denote the product structure as xy^{T} where x is a Mₐ×1 weight vector related to the horizontal (azimuth) dimension, and y is a Mₑ×1 weight vector related to the elevation dimension (which as stated above will be dimensioned by Mₑ virtual antennas which is less than or equal to the number of physical elevation antennas). For example, an antenna array may consist of 8 total antennas with the antennas arranged in a Mₑ×Mₐ fashion with Mₑ=2 rows and Mₐ=4 azimuth antennas in each row. In this case x is a 4 by 1 vector, and y is a 2 by 1 vector. In a simplistic way, x can be treated as a two-dimensional beamforming weight, and y can be treated as a co-phasing vector to combine the energy from two rows constructively at the UE (i.e., to create the desired elevation downtilt at the UE). Let the antennas (which as mentioned may be virtual antennas) on the first row be [1 2 3 4], and antennas on the second row be [1′ 2′ 3′ 4′].

FIG. 3 shows such an example of an antenna array 12 with 8 antennas arranged in 4 columns and 2 rows for implementing embodiments of the invention (in general it can be Mₑ×Mₐ antenna array). The first row comprises antennas P1, P2, P3 and P4, and the second row comprises antennas P1′, P2′, P3′ and P4′.

A continuous or step-wise incremental/decremented phase ramp may be used between the signals for the antennas on the first row and the signals for the antennas on the second row in the frequency domain. For this example, the phase difference y applied between the two rows of antennas determines the resulting downtilt that the transmitted signal will experience. A different phase difference between two rows of antennas may be tried out in the frequency domain to create two different downtilt values across the frequency domain: for example when transmitting two PRBs: PRB1 and PRB2, on PRB1, one phase difference may be used to combine the two antenna rows: the same baseband signal can be routed to antennas on the same location on both rows, e.g., P1 and P1′, P2 and P2′, . . . , P4 and P4′, but for the PRB2 a phase difference may be used that is different from that used for PRB1, thus providing the different downtilt angles for transmitting PRB1 and PRB2. In an actual antenna construction, multiple rows instead of two rows of antennas may be used. Thus the plurality of downtilt angles may be formed by beamforming each column with a beamforming vector that corresponds to the downtilt angle.

At the UE side, some CQI feedback schemes existing from 3GGP Release 8 (and later versions) may be used advantageously. There are two CQI feedback schemes which are especially useful: best M and BP-best. In best M, the UE can feedback a prescribed number of preferred subbands among all the subbands, and a single preferred PMI is assumed for those preferred subbands. With the best M scheme, the M PRBs preferred by the UE are likely to be the ones transmitted with the preferred downtilt value, and the feedback report will therefore enable the networking element to determine the best downtilt value to use with future transmissions (the best downtilt value (or equivalently the best phase difference y) will be the values that were used to transmit the PRBs/subbands that were preferred by the UE). In the table below, the number “M” is specified for various system bandwidths as follows:

| System Bandwidth | M |
|---|---|
| 1.4 MHz | 1 |
| 5 MHz | 3 |
| 10 MHz | 5 |
| 20 MHz | 6 |

In the BP best scheme, the UE may be required to feedback the best subband in a bandwidth part. A bandwidth part is typically 5 MHz for larger bandwidth systems such as 20 MHz, 15 MHz and 10 MHz. If the eNB scans the whole possible range of phase difference between 0 degree and 360 degree in 5 MHz, the subband with a good approximate to y can be selected in a similar way as in the best M.

According to a further embodiment, starting from these two feedback baseline schemes where the whole range of phase difference in [0 360] degrees is scanned, we can also build phase scan schemes where different CSI-RS resources which are standardized in 3GPP Release 11 may be used to scan different segments of [0 360] degrees. For example, for a CSI resource 1, the phase difference between two rows of antennas in a range of [0 180] degrees may be scanned; and for a CSI resource 2, the phase difference between two rows of antennas in a range of [180 360] degrees may be scanned. Alternatively, the scanning in segments can take place in the time domain as well. For example, with a CSI-RS period at 2 ms, the CSI-RS resource in subframe 0 may be used to scan [0 180] degrees; and in subframe 2 it can be used to scan [180 360] degrees. Furthermore, a combination of scanning over more than one CSI-RS resources and over the time domain is also possible.

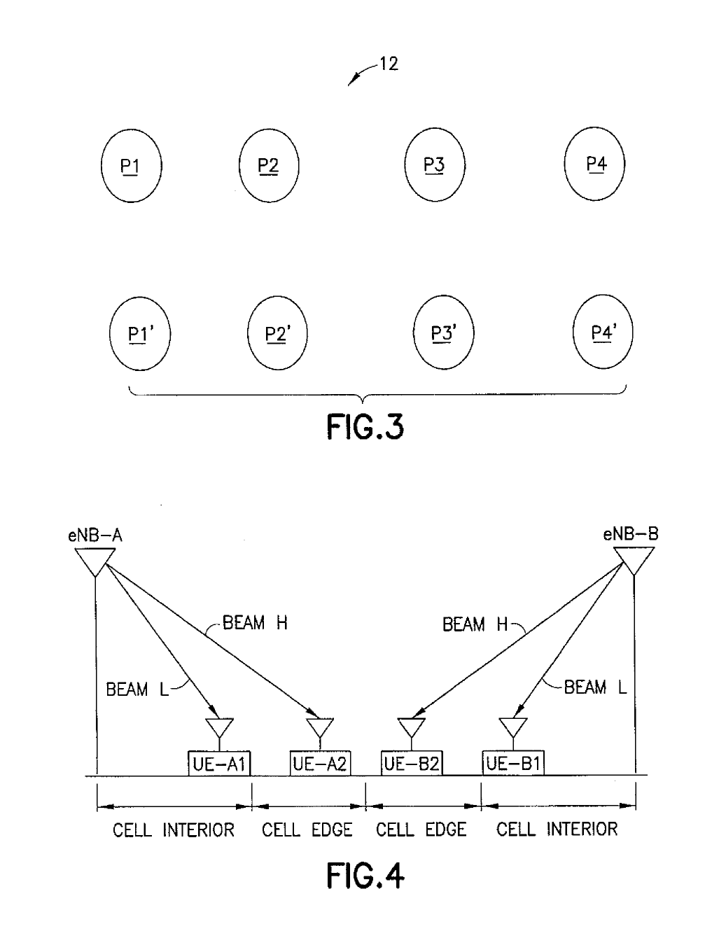

FIG. 4 shows an example how elevation beamforming can be used in a network to provide better communication, e.g., to enhance cell edge coverage and cell throughput, according to an exemplary embodiment of the invention in the context of the CSI feedback. Each of two access nodes eNB-A and eNB-B can provide at least two beams H and L having different elevations (downtilt angles) and subbands. The beam L for each of the cells (eNB-A and eNB-B) is best (strongest signal) in the cell interior in both cells for UEs UE-A1 and UE-B1, which would be indicated in the CSI feedback report by the corresponding UEs using best selected subband indication for the beam L. On the other hand, the beam H for each of the cells is best (strongest signal) in the cell edge in both cells for UEs UE-A2 and UE-B2, which would be indicated in the CSI feedback report by corresponding UEs using best selected subband indication for the beam H.

However it could be beneficial if the eNBs can coordinate their use of the beam L and beam H since when the beam H-activating more interference may be transmitted to the neighboring eNB. For example on a first PRB the eNB-A can transmit the CSI-RS using the beam H and the eNB-B can transmit CSI-RS using the beam L. Then on a second PRB the eNB-A can transmit the CSI-RS using the beam L and the eNB-B can transmit the CSI-RS using the beam H. In this case not only would a cell-edge UE have better signal power, but its interference from the neighboring cell would be less as well.

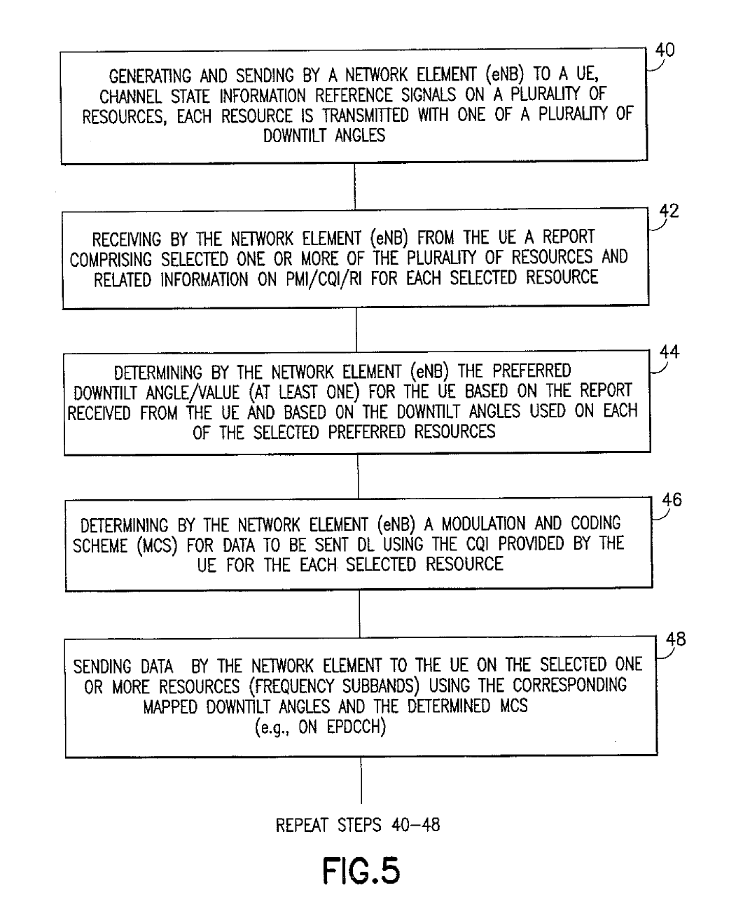

FIG. 5 shows an exemplary flow chart demonstrating implementation of embodiments of the invention by a network element (e.g., eNB). It is noted that the order of steps shown in FIG. 5 is not absolutely required, so in principle, the various steps may be performed out of the illustrated order. Also certain steps may be skipped, different steps may be added or substituted, or selected steps or groups of steps may be performed in a separate application.

In a method according to the exemplary embodiment shown in FIG. 5, in a first step 40, the network element (eNB) generates and sends to a UE a channel state information reference signals (CSI-RS) on a plurality of resources/PRBs (e.g., frequency subbands), each resource is transmitted with one of a plurality of downtilt angles. In a next step 42, the network element (eNB) receives from the UE a report comprising selected one or more of the plurality of resources and related information on PMI/CQI/RI for each selected resource.

In a next step 44, the network element (eNB) determines the preferred downtilt for the UE based on the report received from the UE and based on the downtilt angle(s) used on each of the selected preferred resources. In a next step 46, the network element (eNB) determines a modulation and coding scheme (MCS) for data to be sent DL using the CQI provided by the UE for the each selected resource. In a next step 48, the network element (eNB) sends data to the UE on the selected one or more resources (e.g., frequency subbands) using the corresponding mapped downtilt angles and the determined MCS (e.g., on EPDCCH or EPDSCH).

It is further noted that according to a further embodiment, steps 40-48 can be repeated on a continuous basis.

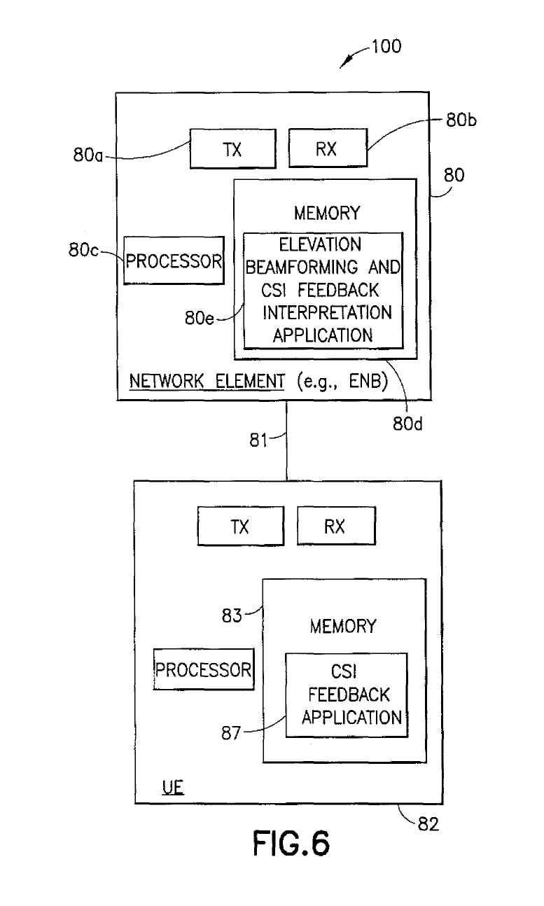

FIG. 6 shows an example of a block diagram demonstrating LTE devices including a network element (e.g., eNB) 80 comprised in a network 100, and a UE 82 communicating with the eNB 80, according to an embodiment of the invention. FIG. 6 is a simplified block diagram of various electronic devices that are suitable for practicing the exemplary embodiments of this invention, and a specific manner in which components of an electronic device are configured to cause that electronic device to operate. The UE 82 may be a mobile phone, a camera mobile phone, a wireless video phone, a portable device or a wireless computer, etc.

The eNB 80 may comprise, e.g., at least one transmitter 80a at least one receiver 80b, at least one processor 80c at least one memory 80d and an elevation beamforming and CSI feedback interpretation application module 80e. The transmitter 80a and the receiver 80b may be configured to provide a wireless communication with the UE 82 (and others not shown in FIG. 6), e.g., through a corresponding link 81, according to the embodiments of the invention. The transmitter 80a and the receiver 80b may be generally means for transmitting/receiving and may be implemented as a transceiver, or a structural equivalence thereof. It is further noted that the same requirements and considerations are applied to transmitter and receiver of the UE 82.

Various embodiments of the at least one memory 80d (e.g., computer readable memory) may include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the processor 80c include but are not limited to general purpose computers, special purpose computers, microprocessors, digital signal processors (DSPs) and multi-core processors. Similar embodiments are applicable to memories and processors in other wireless devices such as the UE 82 shown in FIG. 6.

The elevation beamforming and CSI feedback interpretation application module 80e may provide various instructions for performing steps 40-48 shown in FIG. 5. The module 80e may be implemented as an application computer program stored in the memory 80d, but in general it may be implemented as software, firmware and/or hardware module or a combination thereof. In particular, in the case of software or firmware, one embodiment may be implemented using a software related product such as a computer readable memory (e.g., non-transitory computer readable memory), computer readable medium or a computer readable storage structure comprising computer readable instructions (e.g., program instructions) using a computer program code (i.e., the software or firmware) thereon to be executed by a computer processor. Furthermore, the module 80e may be implemented as a separate block or may be combined with any other module/block of the device 80, or it may be split into several blocks according to their functionality.

The UE 82 may have similar components as the eNB 80, as shown in FIG. 6, so that the above discussion about components of the eNB 80 is fully applicable to the components of the UE 82.

A CSI feedback application module 87 in the UE 82 may assist the eNB 80 to perform step 44 in response to step 42 shown in FIG. 5. The module 87 may be implemented as an application computer program stored in the memory 83 of UE, but in general it may be implemented as software, firmware and/or hardware module or a combination thereof. In particular, in the case of software or firmware, one embodiment may be implemented using a software related product such as a computer readable memory (e.g., non-transitory computer readable memory), computer readable medium or a computer readable storage structure comprising computer readable instructions (e.g., program instructions) using a computer program code (i.e., the software or firmware) thereon to be executed by a computer processor. Furthermore, the module 87 may be implemented as a separate block or may be combined with any other module/block of the device 82, or it may be split into several blocks according to their functionality.

It is noted that various non-limiting embodiments described herein may be used separately, combined or selectively combined for specific applications.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the present invention. Numerous modifications and alternative arrangements may be devised by those skilled in the art without departing from the scope of the invention, and the appended claims are intended to cover such modifications and arrangements.

What is claimed is:

1. A method comprising:
generating and sending by a network element to a user equipment, reference signals on a plurality of resources, each resource is sent with one of a plurality of downtilt angles;
receiving by the network element from the user equipment a feedback report comprising information on selected one or more of the plurality of resources; and
determining by the network element at least one preferred downtilt angle for the user equipment based on the information comprised in the feedback report.

2. The method of claim 1, wherein the information contains channel state information.

3. The method of claim 1, wherein the feedback report comprises precoding matrix index/channel quality indicator/rank indicator for the selected one or more of the plurality of resources, and the reference signals are channel state information reference signals.

4. The method of claim 1, wherein each resource of the plurality of resources is a physical resource block comprising one or more of: a frequency subband component and a time component.

5. The method of claim 1, wherein the selected one or more of the plurality of resources are frequency subbands which are received by the network element based on a frequency selective channel state information feedback message comprised in the feedback report from the UE.

6. The method of claim 1, wherein the selected one or more of the plurality of the resources are frequency subbands which are received by the network element based on a best M feedback scheme reporting or a best bandwidth part feedback scheme reporting.

7. The method of claim 1, further comprising:
sending data by the network element to the user equipment on the selected one or more resources using the at least one corresponding preferred downtilt angle.

8. The method of claim 7, wherein a modulation and coding scheme for the sent data is determined by the network element using a channel quality indicator provided by the user equipment for each selected resource on which the data is sent.

9. The method of claim 7, wherein the data is sent on an enhanced physical downlink control channel.

10. The method of claim 1, wherein the feedback report is received by the network element using multiple messages from the user equipment.

11. The method of claim 1, wherein the network element is an eNB.

12. The method of claim 1, wherein the network element comprises an antenna array arranged in m rows and k columns, m and k being finite integers of more than one, where the plurality of downtilt angles are formed by beamforming each column with a beamforming vector that corresponds to the downtilt angle.

13. An apparatus comprising:
a processing system comprising at least one processor and a memory storing a set of computer instructions, in which the processing system is arranged to cause the apparatus to:
generating and sending to a user equipment, reference signals on a plurality of resources, each resource is sent with one of a plurality of downtilt angles;
receiving from the user equipment a feedback report comprising information on selected one or more of the plurality of resources; and
determining at least one preferred downtilt angle for the user equipment based on the information comprised in the feedback report.

14. The apparatus of claim 13, wherein the feedback report comprises precoding matrix index/channel quality indicator/rank indicator for the selected one or more of the plurality of resources, and the reference signals are channel state information reference signals.

15. The apparatus of claim 13, wherein each resource of the plurality of resources is a physical resource block comprising one or more of: a frequency subband component and a time component.

16. The apparatus of claim 13, wherein the selected one or more of the plurality of the resources are frequency subbands which are received by the network element based on a best M feedback scheme reporting or a best bandwidth part feedback scheme reporting

17. The apparatus of claim 13, wherein the selected one or more of the plurality of resources are frequency subbands which are received by the network element based on a frequency selective channel state information feedback message comprised in the feedback report from the UE.

18. The apparatus of claim 13, wherein the processing system is arranged to further cause the apparatus to:
send data to the user equipment on the selected one or more resources using the at least one corresponding preferred downtilt angle, wherein a modulation and coding scheme for the sent data is determined by the apparatus using the channel quality indicator provided by the user equipment for each selected resource on which the data is sent.

19. The apparatus of claim 18, wherein the data is sent on an enhanced physical downlink control channel.

20. The apparatus of claim 13, wherein the feedback report is received by the apparatus using multiple messages from the user equipment.

21. The apparatus of claim 13, wherein the apparatus comprises an eNB.

22. The apparatus of claim 13, wherein the apparatus comprises an antenna array arranged in m rows and k columns, m and k being finite integers of more than one, where the plurality of downtilt angles are formed by beamforming each column with a beamforming vector that corresponds to the downtilt angle.

23. A computer program product comprising a computer readable medium bearing computer program code embodied herein for use with a computer, the computer program code comprising:
code for generating and sending to a user equipment, reference signals on a plurality of resources, each resource is sent with one of a plurality of downtilt angles;
code for receiving from the user equipment a feedback report comprising information on selected one or more of the plurality of resources; and
code for determining at least one preferred downtilt angle for the user equipment based on the information comprised in the feedback report.

24. The computer program product of claim 23, wherein the information contains channel state information.

25. The computer program product of claim 23, wherein the feedback report comprises precoding matrix index/channel quality indicator/rank indicator for the selected one or more of the plurality of resources, and the reference signals are channel state information reference signals.
